(19) United States
(12) Patent Application Publication
(10) Pub. No.: US 2025/0003454 A1
(43) Pub. Date: Jan. 2, 2025

(54) CONSTANT VELOCITY JOINT FOR PROPELLER SHAFT AND PROPELLER SHAFT

(71) Applicant: Hitachi Astemo, Ltd., Hitachinaka-shi, Ibaraki (JP)

(72) Inventors: Hidekazu AOKI, Hitachinaka-shi, Ibaraki (JP); Kenichiro ISHIKURA, Hitachinaka-shi, Ibaraki (JP)

(73) Assignee: Hitachi Astemo, Ltd., Hitachinaka-shi, Ibaraki (JP)

(21) Appl. No.: 18/689,333

(22) PCT Filed: Jul. 7, 2022
(86) PCT No.: PCT/JP2022/026935

§ 371 Date: Mar. 5, 2024

(30) Foreign Application Priority Data
Sep. 10, 2021 (JP) 2021-147400

(51) Int. Cl. F16D 3/226; F16C 3/02; F16D 3/223

(52) U.S. Cl. CPC F16D 3/2265; F16C 3/023; F16D 2003/22309

(57) ABSTRACT

A constant velocity joint for a propeller shaft which is provided between a first propeller shaft and a second propeller shaft of a propeller shaft to connect the first propeller shaft and the second propeller shaft comprises an outer race member formed into a cylindrical shape, to which the first propeller shaft is connected, the outer race member including an outer race groove portion provided at an inner periphery of the outer race member in a recessed manner at a predetermined angle with respect to a rotational axis direction of the constant velocity joint; a ball member disposed in the outer race groove portion; a cage provided on an inner peripheral side of the outer race member and provided with a window portion that retains the ball member; and an inner race member provided on an inner peripheral side of the cage and connected to the second propeller shaft, the inner race member including an inner race groove portion provided at an outer periphery of the inner race member in a recessed manner so as to intersect with the outer race groove portion, the inner race groove portion in which the ball member is disposed; and a recessed portion formed on a second propeller shaft side in a bottom portion of the inner race groove portion to have a smaller diameter than rest of the bottom portion of the inner race groove portion.

### TECHNICAL FIELD

The invention relates to constant velocity joints for propeller shafts and to propeller shafts.

### BACKGROUND ART

Patent Literature 1 discloses a cross groove type constant velocity joint including an outer race member with an outer race groove portion formed in the inner side thereof and an inner race member with an inner race groove portion formed in the outer side thereof. The outer race groove portion and the inner race groove portion each include a slanted portion having a predetermined angle with respect to a rotational axis direction of the constant velocity joint, and a straight portion that is continuous from the slanted portion and extends along the rotational axis direction. The constant velocity joint further includes a cage disposed between the outer race member and the inner race member, and a ball disposed in a window portion that is opened in the cage, the ball being provided between the outer race groove portion and the inner race groove portion.

### CITATION LIST

### Patent Literature

PTL 1: JP 7-71468 A

### SUMMARY OF INVENTION

### Technical Problem

According to the cross groove type constant velocity joint described in Patent Literature 1, when the slide amount of the constant velocity joint is increased, the window portion of the cage is increased in circumferential width, whereas the wall portions adjacent to the window portion of the cage are decreased in circumferential width. Consequently, the constant velocity joint is lowered in strength. The increase of window width in the cage is therefore prevented by the ball being displaced from the slanted portion to the straight portion in the outer race groove portion. However, such a problem solution method requires both the outer and inner race members to be worked in the same manner and might raise working costs.

One of objects of the present invention is to provide a constant velocity joint for a propeller shaft and a propeller shaft, in which only either one of the outer race member and the inner race member is worked, to restrain a working cost increase.

### Solution to Problem

A constant velocity joint for a propeller shaft which is provided between a first propeller shaft and a second propeller shaft of a propeller shaft according to one embodiment of the invention to connect the first propeller shaft and the second propeller shaft comprises an outer race member formed into a cylindrical shape, to which the first propeller shaft is connected, the outer race member including an outer race groove portion provided at an inner periphery of the outer race member in a recessed manner at a predetermined angle with respect to a rotational axis direction of the constant velocity joint; a ball member disposed in the outer race groove portion; a cage provided on an inner peripheral side of the outer race member and provided with a window portion that retains the ball member; and an inner race member provided on an inner peripheral side of the cage and connected to the second propeller shaft, the inner race member including an inner race groove portion provided at an outer periphery of the inner race member in a recessed manner so as to intersect with the outer race groove portion, the inner race groove portion in which the ball member is disposed, and a recessed portion formed on the second propeller shaft side in a bottom portion of the inner race groove portion to have a smaller diameter than rest of the bottom portion of the inner race groove portion.

The constant velocity joint for a propeller shaft and the propeller shaft according to the one embodiment of the invention thus makes it possible to restrain a working cost increase.

### BRIEF DESCRIPTION OF DRAWINGS

FIG. 1 shows a propeller shaft of Embodiment 1.

FIG. 2 is a cross-sectional view of a constant velocity joint of Embodiment 1.

FIG. 3 is a single item view of an inner race member of the constant velocity joint of Embodiment 1.

FIG. 4 is a single item view of a cage of the constant velocity joint of Embodiment 1.

FIG. 5 shows the constant velocity joint of Embodiment 1 at a collision.

FIG. 6 shows a state before a stub shaft is mounted on the constant velocity joint of Embodiment 1.

FIG. 7 is a cross-sectional view of an inner race member of a constant velocity joint of Embodiment 2.

FIG. 8 is a cross-sectional view of an inner race member of a constant velocity joint of Embodiment 3.

FIG. 9 is a cross-sectional view of a constant velocity joint of Embodiment 4 at a collision.

### DESCRIPTION OF EMBODIMENTS

### Embodiment 1

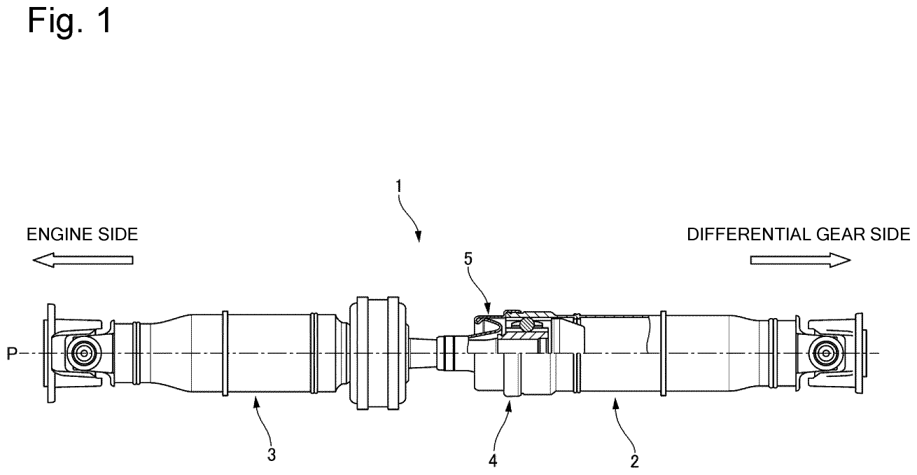

FIG. 1 shows a propeller shaft of Embodiment 1.

### (Configuration of the Propeller Shaft)

A propeller shaft 1 comprises a first propeller shaft 2 coupled to a differential gear, not shown, a stub shaft (second propeller shaft) 3 connected to an output shaft of a transmission coupled to an engine, not shown, which is a drive source, a constant velocity joint 4 connecting the first propeller shaft 2 and the stub shaft 3, and a boot 5 that seals a gap between the stub shaft 3 and the constant velocity joint 4.

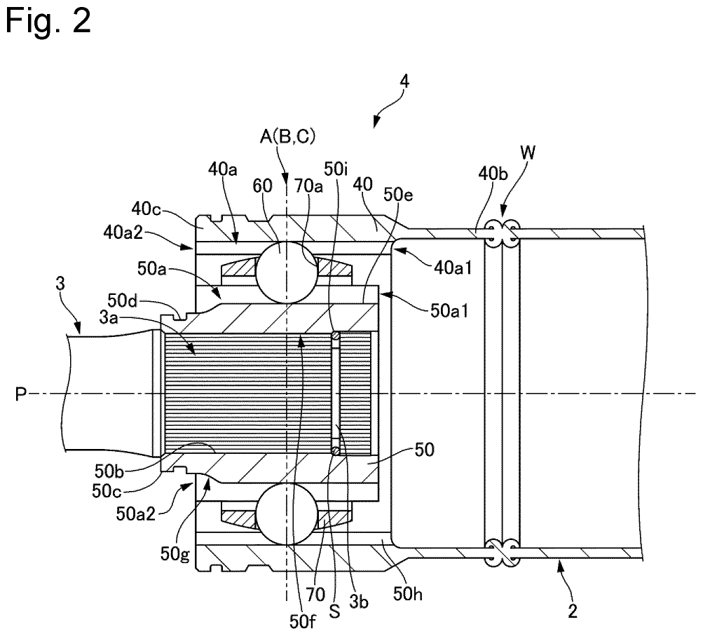

FIG. 2 is a cross-sectional view of the constant velocity joint of Embodiment 1.

### (Configuration of the Constant Velocity Joint)

The constant velocity joint 4 comprises an outer race member 40, an inner race member 50, a cage 70 disposed between the outer race member 40 and the inner race member 50, and a ball 60 retained in an open window portion 70a of the case 70 to couple the outer race member 40 and the inner race member 50.

### (Configuration of the Outer Race)

The outer race member 40 formed into a cylindrical shape includes a first outer race end portion 40b on the first propeller shaft 2 side and a second outer race end portion 40c on the second propeller shaft 3 side.

The first outer race end portion 40b is connected through a welded portion W to the first propeller shaft 2 having a tubular shape.

Formed at an inner periphery of the outer race member 40 is an outer race groove portion 40a. The outer race groove portion 40a includes a first outer race groove end portion 40al on the first propeller shaft 2 side and a second outer race end portion 40a2 on the stub shaft 3 side. The outer race groove portion 40a is provided in a recessed manner so as to be angled to a rotational axis P of the constant velocity joint 4. The ball (ball member) 60 is disposed in the outer race groove portion 40a.

The outer race groove portion 40a includes an outer race groove neutral position A, at which the outer race groove portion 40a abuts against the ball 60, between the first outer race groove end portion 40al and the second outer race end portion 40a2.

### (Configuration of the Cage)

The cage 70 is provided on the inner peripheral side of the outer race member 40 and includes the open window portion 70a that retains the ball 60.

### (Configuration of the Inner Race)

The inner race member 50 is provided on the inner peripheral side of the cage 70 and connected to the stub shaft 3.

Formed at an outer periphery of the inner race member 50 are an inner race groove portion 50a, a small diameter portion 50c, and a jig engagement concave portion 50d. The inner race groove portion 50a includes a first inner race groove end portion 50al on the first propeller shaft 2 side and a second inner race groove end portion 50a2 on the stub shaft 3 side. The inner race groove portion 50a is provided in a recessed manner so as to be angled to the rotational axis P of the constant velocity joint 4 and intersect with the outer race groove portion 40a. The inner race groove portion 50a includes a bottom portion 50e and a wall portion 50h. The ball 60 is disposed in the inner race groove portion 50a. The small diameter portion 50c is formed in a stub shaft 3-side end portion of the inner race member 50. The small diameter portion 50c is smaller in diameter than the bottom portion 50e of a later-discussed recessed portion 50g of the inner race groove portion 50a. The jig engagement concave portion 50d is formed in the small diameter portion 50c. The jig engagement concave portion 50d is smaller in diameter than the smaller diameter portion 50c.

The inner race groove portion 50a includes an inner race groove neutral position B between the first inner race groove end portion 50al and the second inner race groove end portion 50a2. The inner race groove portion 50a abuts against the ball 60 at the inner race groove neutral position B.

In the bottom portion 50e of the second inner race groove end portion 50a2 of the inner race groove portion 50a, the recessed portion 50g having an arc-like shape is formed to have a smaller diameter than rest of the bottom portion 50e of the inner race groove portion 50a.

In other words, the recessed portion 50g is so formed that distance to the rotational axis P of the constant velocity joint 4 is decreased as the recessed portion 50g approaches the stub shaft 3 in the direction of the rotational axis P of the constant velocity joint 4.

Accordingly, the ball 60 can make a smooth sliding motion when displaced to the recessed portion 50g.

A through-hole 50b is formed at an inner periphery of the inner race member 50. The through-hole 50b includes an inner peripheral surface in which an internal spline portion 50f and a snap ring engagement groove portion 50i are formed.

Formed in an outer peripheral surface of an end portion of the stub shaft 3 are an external spline portion 3a and a snap ring receiving groove 3b that retains a snap ring S.

The external spline portion 3a and the snap ring receiving groove 3b retaining the snap ring S in the stub shaft 3 are inserted in the through-hole 50b of the inner race member 50. The external spline portion 3a of the stub shaft 3 is meshed with the internal spline portion 50f of the inner race member 50. At the same time, an outer periphery of the snap ring S is engaged with the snap ring engagement groove portion 50i of the inner race member 50. The stub shaft 3 and the inner race member 50 are thus fixedly connected together.

The outer race groove neutral position A of the outer race groove portion 40a of the outer race member 40 and the inner race groove neutral position B of the inner race groove portion 50a of the inner race member 50, each at which the ball 60 is located, are where stress acting on the boot 5 is minimum.

It is therefore possible to secure the durability of the boot 5 and thus enhance the durability of the constant velocity joint 4.

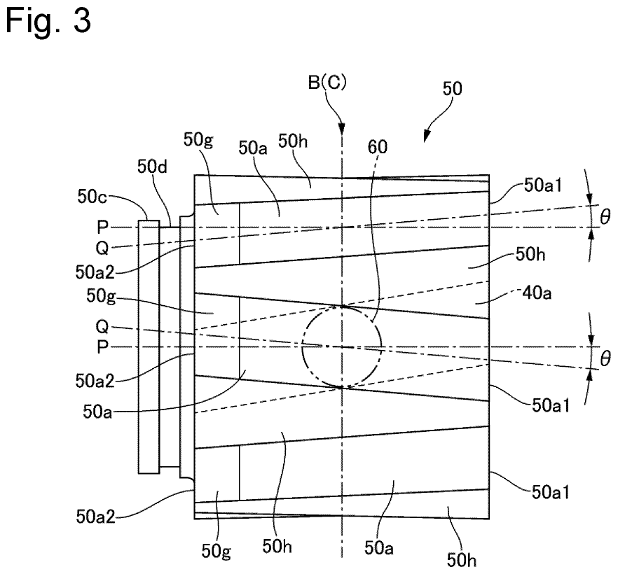

FIG. 3 is a single item view of the inner race member of the constant velocity joint of Embodiment 1.

The inner race groove portion 50a at a center is provided in a recessed manner so that a center line Q thereof is angled at 0 degrees clockwise with respect to the rotational axis P of the constant velocity joint 4.

The inner race groove portion 50a adjacent to and situated on each side of the inner race groove portion 50a at the center is provided in a recessed manner so that a center line Q thereof is angled at 0 degrees anticlockwise with respect to the rotational axis P of the constant velocity joint 4.

The adjacent inner race groove portions 50a are provided to be angled in an opposite direction.

The outer race groove portion 40a shown in broken lines is provided in a recessed manner so as to be angled and intersect with the rotational axis P of the constant velocity joint 4 and the inner race groove portion 50a at the center.

The outer race grove portion 40a adjacent to and situated on each side of the aforementioned outer race groove portion 40a is provided to be angled in an opposite direction as with the inner race groove portions 50a.

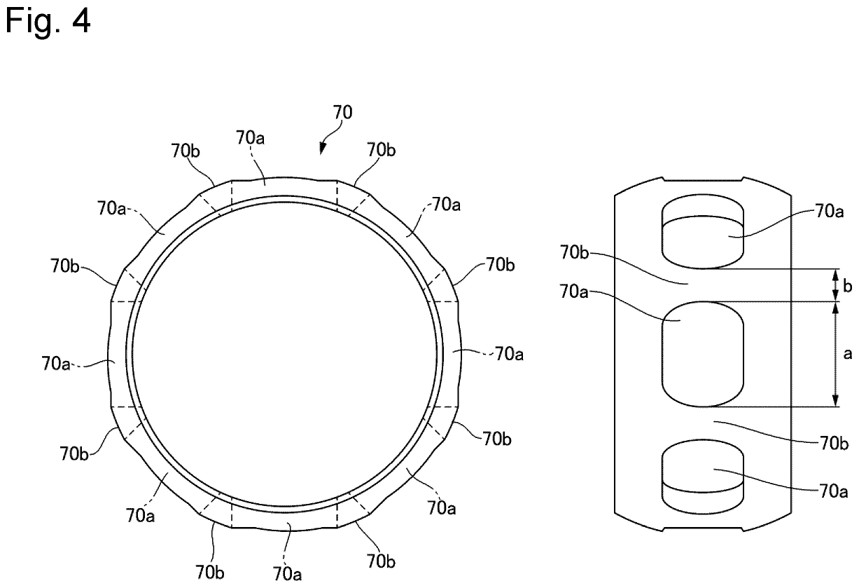

FIG. 4 is a single item view of the cage of the constant velocity joint of Embodiment 1.

The cage 70 includes eight window portions 70a that retain balls 60, and eight wall portions 70b that partition the window portions 70a. The window portions 70a each have a circumferential width a, and the wall portions 70b each have a circumferential width b.

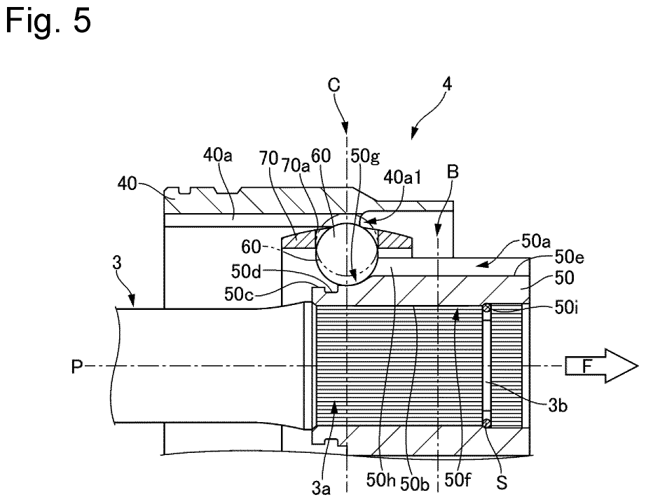

FIG. 5 shows the constant velocity joint of Embodiment 1 at a collision.

More specifically, FIG. 5 shows a situation where, at a vehicle collision, the displacement of the engine displaces the stub shaft 3 and the inner race member 50 in an F direction, and the ball 60 is located in the arc-like recessed portion 50g of the second inner race groove end portion 50a2of the inner race groove portion 50a, which means that the ball 60 is displaced downwards on the drawing from the inner race groove neutral position B where the ball 60 is located as shown by a broken line, to be located as shown by a solid line.

Since the ball 60 falls into the recessed portion 50g as described above, the ball 60 in contact with a side wall of the window portion 70a of the cage 70 can be reduced in diameter.

In other words, the reduction of diameter of the ball 60 in contact with the side wall of the window portion 70a of the cage 70 makes it possible to increase slide amount while the strength of the constant velocity joint 4 is secured without increasing the circumferential width a of the window portion 70a or decreasing the circumferential width b of the wall portion 70b. Working needs to be applied only to the inner race member 50 side, which restrains a working cost increase.

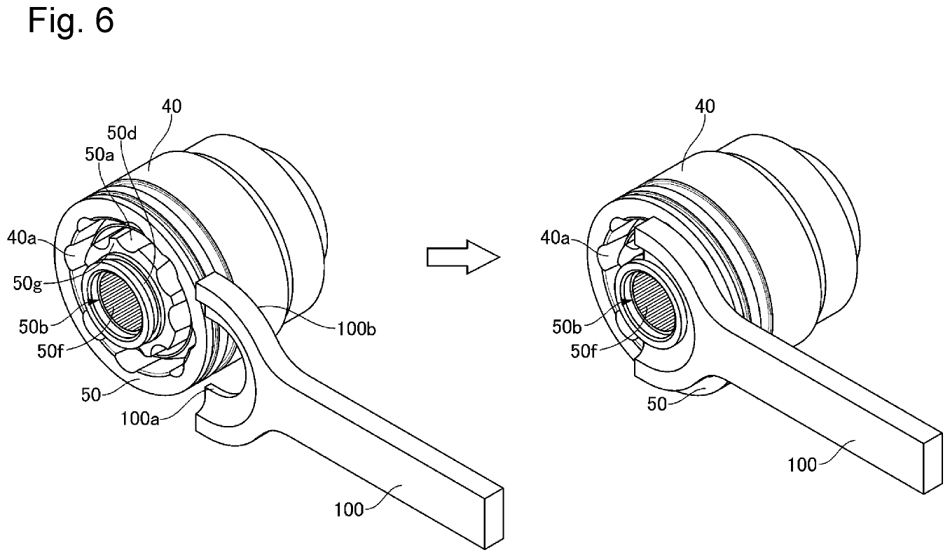

FIG. 6 shows a state before the stub shaft is mounted on the constant velocity joint of Embodiment 1.

Before the subsequent step where the stub shaft 3 is mounted and fastened onto the constant velocity joint 4 on which the outer race member 40, the inner race member 50, and the cage 70 retaining the ball 60 in the window portion 70a are mounted, an engagement portion 100a of a jig 100 is engaged with the jig engagement concave portion 50d of the inner race member 50, and an abutment portion 100b of the jig 100 is brought into abutment against the outer race member 40, to thereby restrain relative displacement between the inner race member 50 and the outer race member 40.

The subsequent step of inserting the stub shaft 3 into the through-hole 50b of the inner race member 50 therefore can be carried out in a state where the outer race member 40, the inner race member 50, and the cage 70 retaining the ball 60 in the window portion 70a are mounted on the constant velocity joint 4. It is therefore possible to enhance assembly workability and also reliability of the propeller shaft 1.

The following discussion explains operation and effects.

The operation and effects of the constant velocity joint for a propeller shaft according to Embodiment 1 are recited below.
(1) The constant velocity joint for a propeller shaft according to Embodiment 1 comprises the outer race member 40 formed into a cylindrical shape, to which the first propeller shaft 2 is connected, the outer race member 40 including the outer race groove portion 40a provided at the inner periphery of the outer race member 40 in a recessed manner at the predetermined angle with respect to the rotational axis P of the constant velocity joint 4; the ball member 60 disposed in the outer race groove portion 40a; the cage 70 provided on the inner peripheral side of the outer race member 40 and provided with the window portion 70a that retains the ball member 60; and the inner race member 50 provided on the inner peripheral side of the cage 70 and connected to the second propeller shaft 3, the inner race member 50 including the inner race groove portion 50a provided at the outer periphery of the inner race member 50 in a recessed manner so as to intersect with the outer race groove portion 40a, the inner race groove portion 50a in which the ball member 60 is disposed, and the recessed portion 50g formed in the bottom portion 50e of the second inner race groove end portion 50a2 of the inner race groove portion 50a to have a smaller diameter than the rest of the bottom portion 50e of the inner race groove portion 50a.

The falling of the ball 60 into the recessed portion 50g makes it possible to reduce the diameter of the ball 60 in contact with the side wall of the window portion 70a of the cage 70 and increase the slide amount while the strength of the constant velocity joint 4 is secured without increasing the circumferential width a of the window portion 70a or decreasing the circumferential width b of the wall portion 70b. In addition, working needs to be applied only to the inner race member 50 side, which restrains a working cost increase.
(2) The recessed portion 50g is formed into an arc-like shape.

This enables the ball 60 to make a smooth sliding motion when displaced to the recessed portion 50g.
(3) The outer race groove neutral position A of the outer race groove portion 40a of the outer race member 40 and the inner race groove neutral position B of the inner race groove portion 50a of the inner race member 50, each at which the ball 60 is located, is where the stress acting on the boot 5 is minimum.

It is therefore possible to secure the durability of the boot 5 and thus enhance the durability of the constant velocity joint 4.
(4) Before the subsequent step where the stub shaft 3 is mounted and fastened onto the constant velocity joint 4 on which the outer race member 40, the inner race member 50, and the cage 70 retaining the ball 60 in the window portion 70a are mounted, the engagement portion 100a of the jig 100 is engaged with the jig engagement concave portion 50d of the inner race member 50, and the abutment portion 100b of the jig 100 is brought into abutment against the outer race member 40, to thereby restrain the relative displacement between the inner race member 50 and the outer race member 40.

The subsequent step of inserting the stub shaft 3 into the through-hole 50b of the inner race member 50 therefore can be carried out in a state where the outer race member 40, the inner race member 50, and the cage 70 retaining the ball 60 in the window portion 70a are mounted on the constant velocity joint 4. This eliminates the necessity of disassembly and reassembly in the subsequent step. Consequently, the propeller shaft 1 is enhanced in assembly workability and also enhanced in reliability as the propeller shaft 1 due to the unnecessity of reassembly.

### Embodiment 2

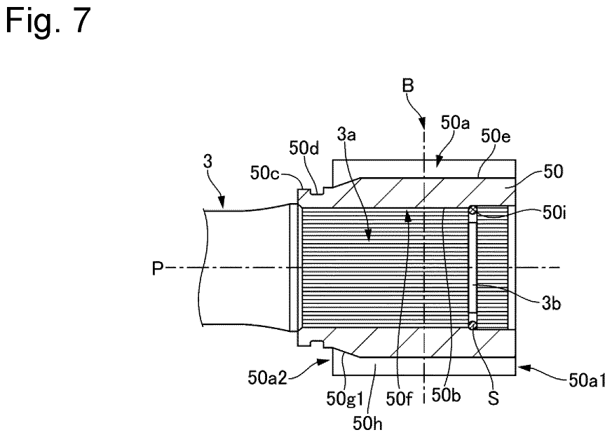

FIG. 7 is a cross-sectional view of an inner race member of a constant velocity joint of Embodiment 2.

In Embodiment 1, the recessed portion 50g provided in the bottom portion 50e of the second inner race groove end portion 50a2 of the inner race groove portion 50a of the inner race member 50 is formed into the arc-like shape so that the distance to the rotational axis P of the constant velocity joint 4 is decreased as the recessed portion 50g approaches the stub shaft 3 in the direction of the rotational axis P of the constant velocity joint 4. In Embodiment 2, the recessed portion 50g provided in the bottom portion 50e of the second inner race groove end portion 50a2 of the inner race groove portion 50a of the inner race member 50 is formed into a straight shape so that the distance to the rotational axis P of the constant velocity joint 4 is decreased as the recessed portion 50g approaches the stub shaft 3 in the direction of the rotational axis P of the constant velocity joint 4.

As other configurations are similar to Embodiment 1, the similar configurations will be provided with the same reference signs as those in Embodiment 1, and explanations thereof will be omitted.

Embodiment 2 provides the operation and effects of Embodiment 1, except for the operation and effects (2), and further provides the operation and effect of facilitating the working.

### Embodiment 3

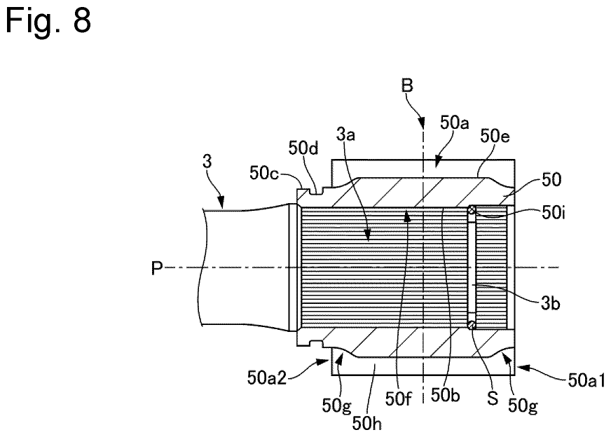

FIG. 8 is a cross-sectional view of a constant velocity joint of Embodiment 3.

Embodiment 1 provides the arc-like recessed portion 50g only in the bottom portion 50e of the second inner race groove end portion 50a2 of the inner race groove portion 50a of the inner race member 50. Embodiment 3, however, provides the arc-like recessed portion 50g in the bottom portion 50e of each of the first and second inner race groove end portions 50al and 50a2 of the inner race groove portion 50a of the inner race member 50.

As other configurations are similar to Embodiment 1, the similar configurations will be provided with the same reference signs as those in Embodiment 1, and explanations thereof will be omitted.

Embodiment 3 provides the operation and effects of Embodiment 1 and further provides the operation and effect of maximizing the slide amount of the constant velocity joint 4.

### Embodiment 4

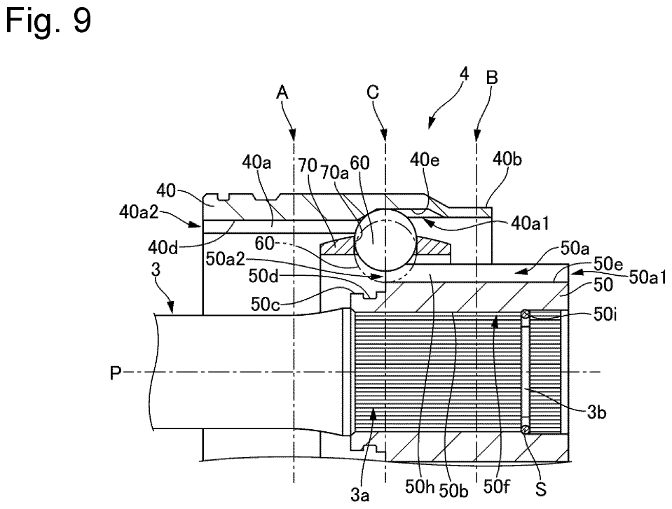

FIG. 9 is a cross-sectional view of a constant velocity joint of Embodiment 4 at a collision.

Embodiment 1 provides the arc-like recessed portion 50g in the bottom portion 50e of the second inner race groove end portion 50a2 of the inner race groove portion 50a of the inner race member 50. Embodiment 4, however, provides a recessed portion 40e in a bottom portion 40d of the first outer race groove end portion 40al of the outer race groove portion 40a of the outer race member 40.

The recessed portion 40e has a concave shape that is formed by forming the bottom portion 40d of the first outer race groove end portion 40al of the outer race groove portion 40a of the outer race member 40 to have a larger diameter than rest of the bottom portion 40d of the outer race groove portion 40a.

As other configurations are similar to Embodiment 1, the similar configurations will be provided with the same reference signs as those in Embodiment 1, and explanations thereof will be omitted.

Accordingly, Embodiment 4 provides similar operation and effects to Embodiment 1.

### OTHER EMBODIMENTS

The embodiments for carrying out the invention have been explained above. Specific configurations of the invention, however, are not limited to those of the embodiments. The invention includes design modifications and the like without deviating from the gist of the invention.

For example, according to Embodiment 4, the recessed portion 40e provided in the first outer race groove end portion 40al of the outer race groove portion 40a of the outer race member 40 has the concave shape. The recessed portion 40e, however, may be formed into an arc-like shape as in Embodiment 1 or a straight shape as in Embodiment 2. The recessed portion 40e also may be provided each of the first and second outer race groove end portions 40al and 40a2 of the outer race groove portion 40a of the outer race member 40 as in Embodiment 3.

The invention is not limited to the foregoing embodiments but may include various modifications. For example, the foregoing embodiments are explained in details for comprehensible explanation of the invention and do not necessarily have to include all the configurations explained above. The configurations of the embodiments may be partially replaced with one another, and the configuration of any one of the embodiments may be incorporated into another one of the embodiments. Any one of the configurations of the embodiments may be partially incorporated into or replaced with the configuration of another one of the embodiments or partially deleted.

The present patent application claims priority under Japanese Patent Application No. 2021-147400 filed on Sep. 10, 2021. The entire disclosure of Japanese Patent Application No. 2021-147400 filed on Sep. 10, 2021 including description, claims, drawings and abstract is incorporated herein by reference in its entity.

### REFERENCE SIGN LIST

1 Propeller shaft; 2 First propeller shaft; 3 Stub shaft (second propeller shaft); 4 Constant velocity joint; 40 Outer race member; 40a Outer race groove portion; 40a1 First outer race groove end portion; 40a2 Second outer race groove end portion; 40d Bottom portion; 40e Concave recessed portion; 50 Inner race member; 50a Inner race groove portion; 50al First inner race groove end portion; 50a2 Second inner race groove end portion; 50c Small diameter portion; 50d Jig engagement concave portion; 50e Bottom portion; 50g Arc-like recessed portion; 50g1 Straight recessed portion; 60 ball (ball member); 70 Cage; 70a Window portion; P Rotational axis of the propeller shaft and the constant velocity joint

1-8. (canceled)

9. A constant velocity joint for a propeller shaft which is provided between a first propeller shaft and a second propeller shaft of a propeller shaft to connect the first propeller shaft and the second propeller shaft, the constant velocity joint for a propeller shaft comprising:
an outer race member formed into a cylindrical shape, to which the first propeller shaft is connected,
the outer race member including an outer race groove portion provided at an inner periphery of the outer race member in a recessed manner at a predetermined angle with respect to a rotational axis direction of the constant velocity joint,
the constant velocity joint for a propeller shaft further comprising:
a ball member disposed in the outer race groove portion;
a cage provided on an inner peripheral side of the outer race member and provided with a window portion that retains the ball member; and
an inner race member provided on an inner peripheral side of the cage and connected to the second propeller shaft,
the inner race member including:
an inner race groove portion provided at an outer periphery of the inner race member in a recessed manner so as to intersect with the outer race groove portion, the inner race groove portion in which the ball member is disposed, and
a recessed portion formed on the second propeller shaft side in a bottom portion of the inner race groove portion to have a smaller diameter than rest of the bottom portion of the inner race groove portion,
wherein the recessed portion is so formed that distance between the recessed portion and a rotational axis of the constant velocity joint is decreased as the recessed portion approaches the second propeller shaft in the rotational axis direction, and
wherein the recessed portion is formed into an arc-like shape.

10. The constant velocity joint for a propeller shaft according to claim 9,
wherein the recessed portion is provided in each of the bottom portion of the inner race groove portion situated on the second propeller shaft side and the bottom portion of the inner race groove portion situated on the first propeller side in the rotational axis direction.

11. The constant velocity joint for a propeller shaft according to claim 9,
wherein the inner race member comprises:
a small diameter portion that is formed between the recessed portion and the second propeller shaft in the rotational axis direction to have a smaller diameter than a bottom portion of the recessed portion, and
a jig engagement concave portion provided in the small diameter portion in a recessed manner.

12. A propeller shaft, the propeller shaft comprising:
a first propeller shaft of the propeller shaft;
a second propeller shaft provided at an opposite position to the first propeller shaft of the propeller shaft; and
a constant velocity joint disposed between the first propeller shaft and the second propeller shaft to connect the first propeller shaft and the second propeller shaft,
the constant velocity joint including:
an outer race member formed into a cylindrical shape, to which the first propeller shaft is connected;
a cage provided on an inner peripheral side of the outer race member and provided with a window portion that retains a ball member; and
an inner race member provided on an inner peripheral side of the cage and connected to the second propeller shaft,
the outer race member including an outer race groove portion provided at an inner periphery of the outer race member and provided in a recessed manner at a predetermined angle with respect to a rotational axis direction of the constant velocity joint,
the ball member being disposed in the outer race groove portion,
the inner race member including:
an inner race groove portion provided at an outer periphery of the inner race member in a recessed manner so as to intersect with the outer race groove portion, the inner race groove portion in which the ball member is disposed, and
a recessed portion formed on the second propeller shaft side in a bottom portion of the inner race groove portion to have a smaller diameter than rest of the bottom portion of the inner race groove portion,
wherein the recessed portion is so formed that distance between the recessed portion and a rotational axis of the constant velocity joint is decreased as the recessed portion approaches the second propeller shaft in the rotational axis direction, and
wherein the recessed portion is formed into an arc-like shape.
